(19) United States
(12) Patent Application Publication
(10) Pub. No.: US 2005/0099526 A1
(43) Pub. Date: May 12, 2005

(54) Device for attaching lens to digital camera

(76) Inventors: Cheng-Hsing Wu, Chong Ho City (TW); Cheng-Feng Wu, Chong Ho City (TW)

Correspondence Address: Cheng Hsing Wu, P. O. Box 10-69, Chong Ho, Taipei, 235, TW

(21) Appl. No.: 10/712,898

(22) Filed: Nov. 11, 2003

(51) Int. Cl. H04N 5/225; G03B 17/00

(52) U.S. Cl. 348/360; 396/530

(57) ABSTRACT

A digital camera includes a camera housing, an auxiliary lens, and an attaching device for attaching various additional or auxiliary lenses to the camera housing, and preferably disposed in front of the optical device of the digital camera, to facilitate the picture taking of the digital camera. The attaching device includes a bracket having a base plate attachable to the camera housing and a panel extended from the base plate to support the auxiliary lens. One or more barrels may further be attached to the panel, to support various auxiliary lenses to the camera housing. A fastener may secure the base plate to the camera housing, and may be attached to tripods.

### BACKGROUND OF THE INVENTION

1. Field of the Invention

The present invention relates to a digital camera, and more particularly to a digital camera having one or more additional or auxiliary lenses to be selectively attached in front of the optical device of the digital camera, to facilitate the picture taking of the digital camera.

2. Description of the Prior Art

Typical cameras comprise an optical device disposed in the front portion of the camera housing, and having a well known structure comprising a lens, a shutter and the like, for forming an image of a photographed subject on a film.

The typical cameras include a large volume that may include one or more mask assemblies to be selectively attached therein, and aligned with the optical device, for composing pictures of different views or background. For example, U.S. Pat. No. 3,940,775 to Bodnar disclosing a typical method or apparatus for multiple exposure optical recording.

The typical cameras may also include one or more additional or auxiliary lenses to be selectively attached in front of the optical device. Normally, the additional or auxiliary lenses are directly secured and attached or threaded to the optical device by threading engagements.

U.S. Pat. No. 6,042,277 to Errington discloses a typical camera flash bracket for attaching flash lights to the typical cameras. Similarly, the typical cameras include a volume large enough to support the camera flash brackets.

Digital cameras have recently been developed and widely provided for taking pictures, and also comprise an optical device disposed in the front portion of the camera housing, and may include a retractable structure. However, the typical digital cameras comprise a tiny volume and have no place to attach and to support the camera flash brackets and the additional or auxiliary lenses.

The typical digital cameras comprise only the typical optical devices attached or provided therein, and no additional or auxiliary lenses may be attached to the front portion of the typical optical devices of the typical digital cameras, such that the picture taking effect of the typical digital cameras may not be facilitated.

The present invention has arisen to mitigate and/or obviate the afore-described disadvantages of the conventional digital cameras.

### SUMMARY OF THE INVENTION

The primary objective of the present invention is to provide a digital camera including one or more additional or auxiliary lenses to be selectively attached in front of the optical device of the digital camera, to facilitate the picture taking of the digital camera.

In accordance with one aspect of the invention, there is provided a digital camera comprising a camera housing, an auxiliary lens, and an attaching device provided for attaching various additional or auxiliary lenses to the camera housing, and preferably disposed in front of the optical device of the digital camera, to facilitate the picture taking of the digital camera.

The attaching device includes a bracket attachable to the camera housing, for supporting the auxiliary lens. The bracket includes a base plate attachable to the camera housing, and a panel extended from the base plate to support the auxiliary lens.

The camera housing includes a screw hole formed therein, the base plate includes an orifice formed therein, and a fastener is engageable through the orifice of the base plate, and engageable with the screw hole of the camera housing, to secure the bracket to the camera housing.

The fastener includes a retaining ring attached thereto, and engageable with the base plate, for anchoring the fastener to the base plate. The fastener includes a stem extended therefrom, and a threaded portion formed on the stem and engageable with the screw hole of the camera housing, to secure the bracket to the camera housing, the retaining ring is engaged onto the stem of the fastener. The fastener may include a screw hole formed therein, for attaching to a tripod.

The bracket includes a pad disposed between the base plate and the camera housing, to protect the camera housing. The panel of the bracket includes an opening formed therein, and an inner thread formed therein for threading to the auxiliary lens.

A barrel may further be provided and attachable to the panel, to support the auxiliary lens. The barrel includes an outer thread for attaching to the panel, and an inner thread for engaging with the auxiliary lens. The barrel may include an additional outer thread formed thereon for attaching to the panel at different position.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view illustrating a digital camera in accordance with the present invention having an additional or auxiliary lens selectively attachable in front of an optical device of the digital camera;

FIG. 2 is a perspective view of a bracket for attaching to the digital camera, to support or attach the additional or auxiliary lens to the digital camera;

FIG. 3 is an exploded view of the bracket;

FIG. 4 is an exploded and cross sectional view of the bracket for the digital camera;

FIG. 5 is a perspective view illustrating an attachment of the digital camera to a tripod;

FIGS. 6, 7 are exploded and cross sectional views similar to FIG. 4, illustrating the other embodiment of the bracket for the digital camera;

FIG. 8 is a perspective view similar to FIG. 3, illustrating the other arrangement of the bracket for the digital camera; and

FIG. 9 is an exploded view illustrating the bracket as shown in FIG. 8.

### DETAILED DESCRIPTION OF THE PREFERRED EMBODIMENT

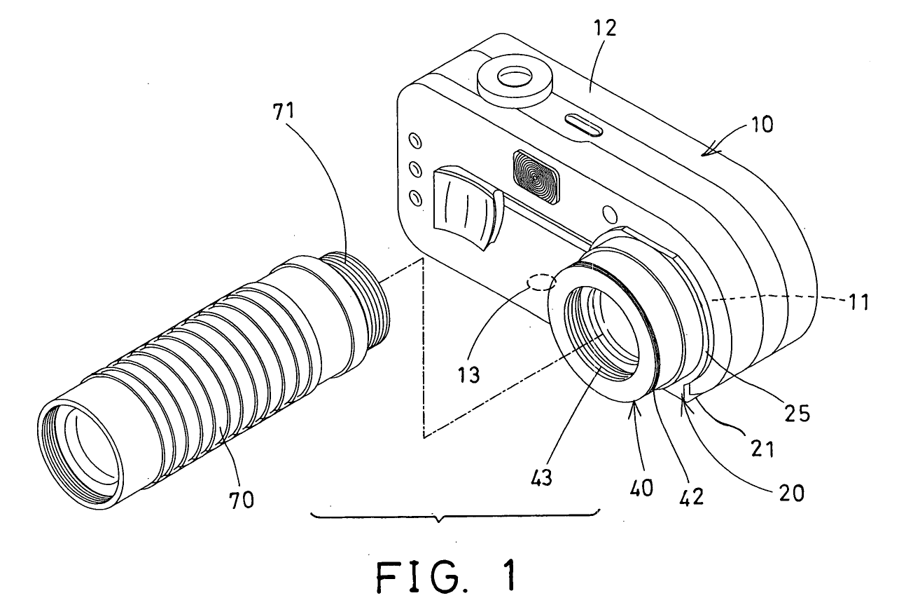

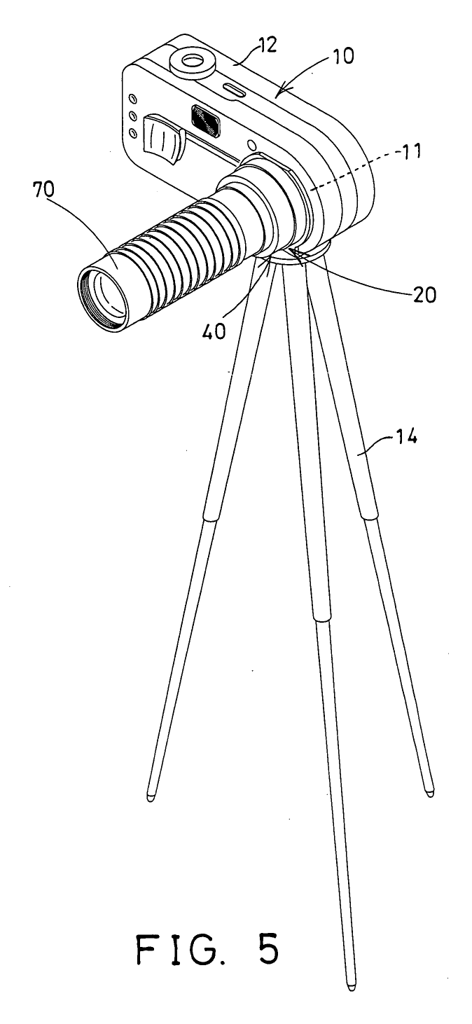

Referring to the drawings, and initially to FIGS. 1 and 5, a digital camera in accordance with the present invention is generally designated with a reference numeral “10”, and comprises a typical optical device 11 disposed in the front portion of a camera housing 12, and having a well known structure comprising a lens (not shown), a shutter (not shown) and the like, for forming an image of a photographed subject on a film (not shown). The camera housing 12 includes a screw hole 13 (FIG. 1) formed in the bottom thereof for attaching to a tripod 14 (FIG. 5) or the like.

The digital camera 10 in accordance with the present invention further includes a bracket 20 for selectively attaching one or more additional or auxiliary lenses 70 to the front portion of the optical device 11 of the digital camera 10, to facilitate the picture taking of the digital camera 10. The typical or additional or auxiliary lenses 70 normally include an outer thread 71 formed therein for attaching to the ordinary cameras.

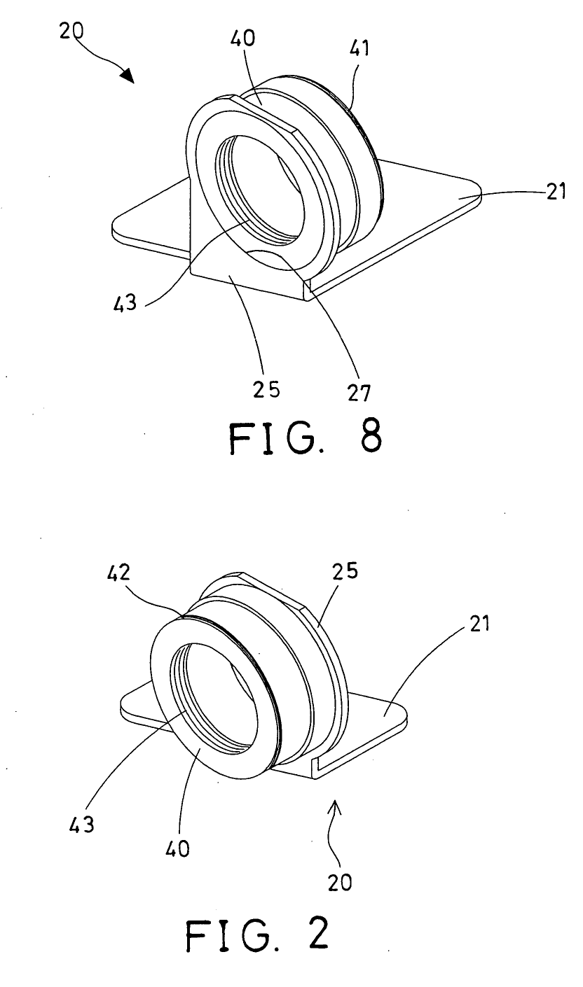

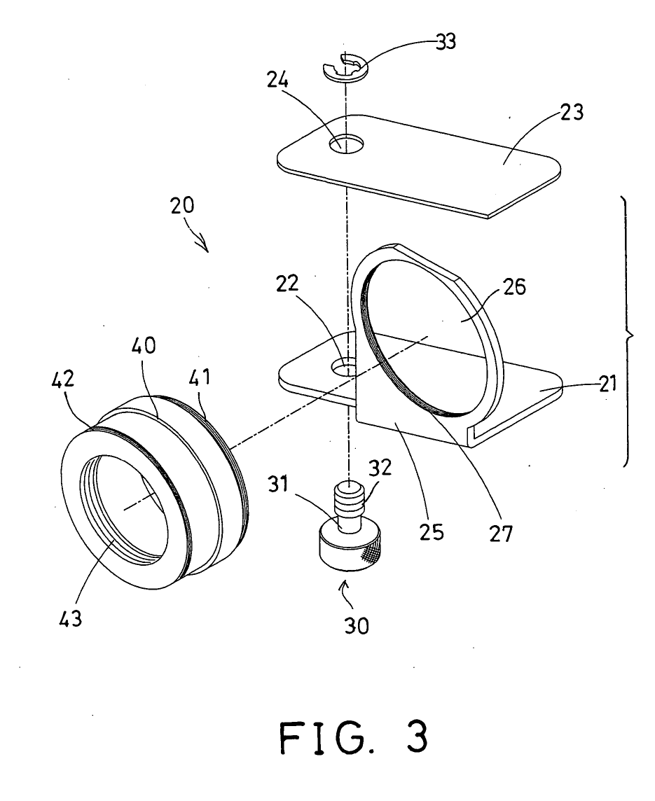

As shown in FIGS. 2-4, the bracket 20 includes a base plate 21 for attaching to the bottom of the camera housing 12. For example, the base plate 21 includes an orifice 22 formed therein for receiving a fastener 30 which may be used to attach or secure the base plate 21 of the bracket 20 to the bottom of the camera housing 12. A resilient pad 23 may further be provided and attached to the base plate 21, for softly or resiliently engaging with the digital camera 10, and for protecting the digital camera 10 from being damaged by the bracket 20. The pad 23 may also includes an aperture 24 formed therein for receiving the fastener 30.

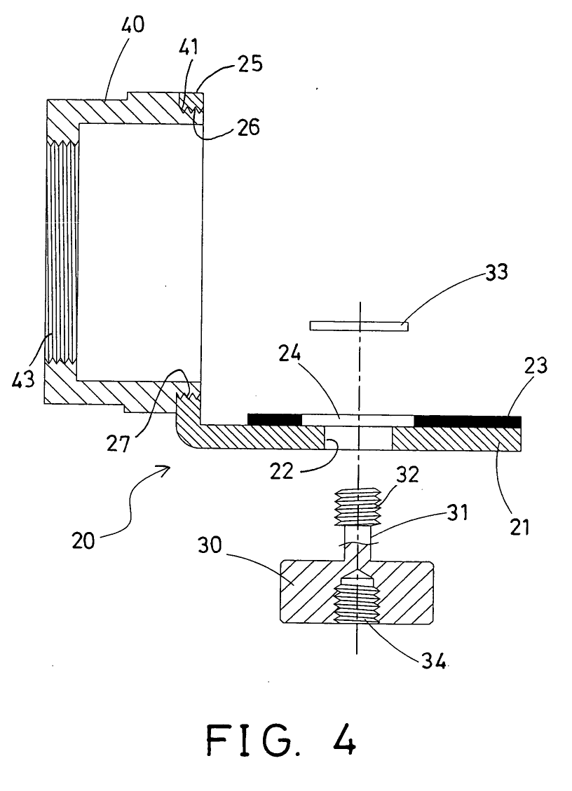

The fastener 30 includes a narrower stem 31 extended therefrom, and a threaded portion 32 formed or provided in the free end portion of the stem 31 and having an outer diameter greater than that of the stem 31. The stem and the threaded portion 32 of the fastener 30 are engageable or extendible outwardly through the orifice 22 of the base plate 21 and the aperture 24 of the pad 23, for threading to the screw hole 13 of the camera housing 12, and thus for attaching or securing the base plate 21 of the bracket 20 to the bottom of the camera housing 12. The fastener 30 may include a screw hole 34 formed therein (FIGS. 4, 6, 7) for threading or attaching to the tripod 14.

A retaining ring 33 is engageable onto the stem 31 of the fastener 30, and engageable with the threaded portion 32 of the fastener 30, and engageable with the base plate 21 of the bracket 20, to retain the retaining ring 33 to the bracket 20, and to prevent the retaining ring 33 from being disengaged from the bracket 20. For example, the retaining ring 33 includes an outer diameter greater than the inner diameter of the orifice 22 of the base plate 21, for allowing the retaining ring 33 to be engaged with and anchored to the base plate 21. The retaining ring 33 may be received in the aperture 24 of the pad 23.

The bracket 20 further includes a panel 25 extended therefrom, such as extended from the base plate 21, and perpendicular to the base plate 21, and having an opening 26 formed therein, and an inner thread 27 formed therein for threading to the outer thread 71 of the additional or auxiliary lenses 70, and thus for allowing the additional or auxiliary lenses 70 to be selectively attached in front of the optical device 11 of the digital camera 10.

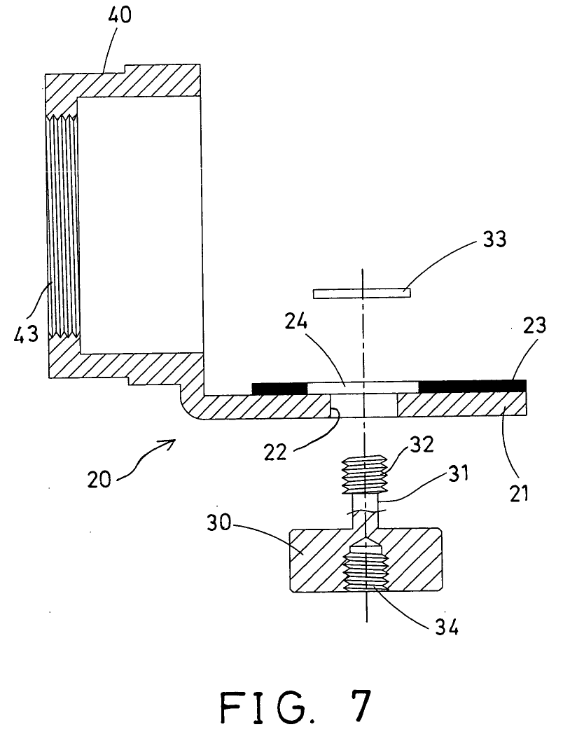

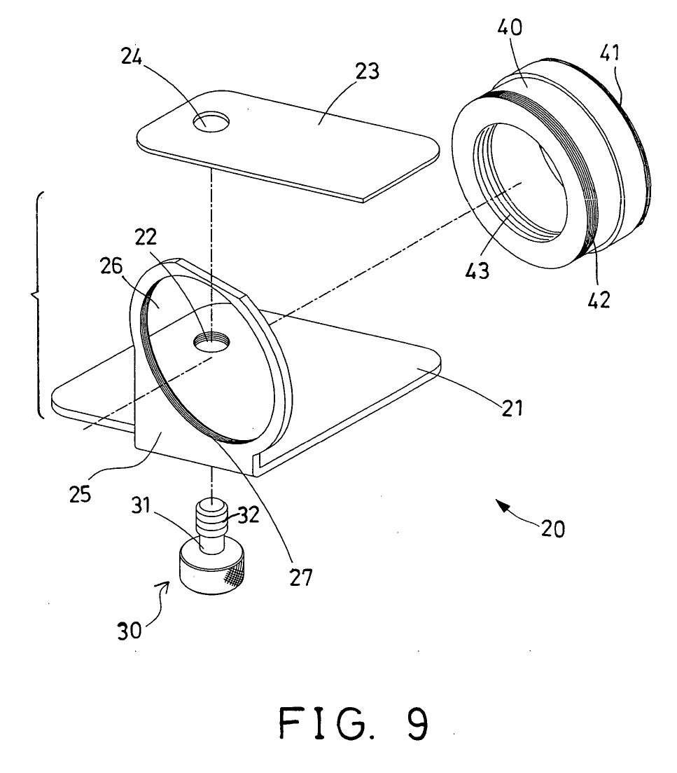

One or more barrels 40 may further be provided and may include one or more outer threads 41, 42 formed on the outer peripheral portion thereof, such as formed in the rear or front or middle portion thereof, for selectively threading with the inner thread 27 of the bracket 20, to selectively attach either of the barrels 40 to the bracket 20. For example, the barrels 40 may be selectively attached to the bracket 20 with the rear outer threads 41 (FIGS. 1-5), or with the front outer threads 42 (FIGS. 8, 9).

As shown in FIGS. 8, 9, in order to support the barrel 40 behind the panel 25, the base plate 21 may include a larger area or width or length. As shown in FIG. 9, the orifice 22 of the base plate 21 may include an inner thread formed therein for engaging with the threaded portion 32 of the fastener 30, and for retaining the fastener 30 to the bracket 20 without the retaining ring 33, and to prevent the fastener 30 from being disengaged from the bracket 20.

The barrel 40 may further include an inner thread 43 formed therein for threading to the outer thread 71 of the additional or auxiliary lenses 70, and thus for allowing the additional or auxiliary lenses 70 to be selectively attached in front of the optical device 11 of the digital camera 10 indirectly with the barrels 40. The inner threads 43 of the barrels 40 may include different inner diameters, for securing and attaching various or different additional or auxiliary lenses 70 to the digital camera 10.

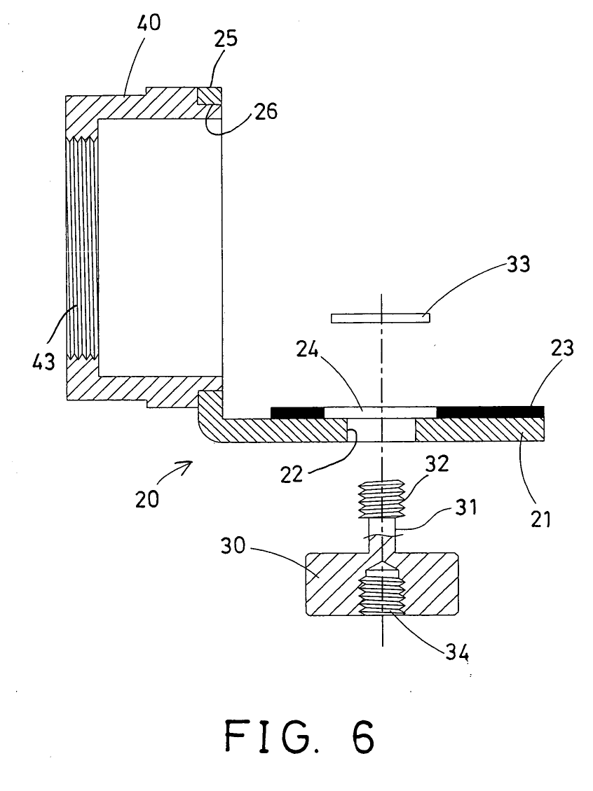

As shown in FIG. 6, the barrel 40 may also be engaged into the opening 26 of the panel 25 and secured to the panel 25 of the bracket 20 with such as force-fitted engagements, adhesive materials, or by welding processes, or the like; or may be formed as a one-integral-piece with the bracket 20 (FIG. 7). Without the bracket 20 and/or the barrels 40, the additional or auxiliary lenses 70 may not be attached to the digital camera 10.

Accordingly, the digital camera in accordance with the present invention includes one or more additional or auxiliary lenses to be selectively attached in front of the optical device of the digital camera, to facilitate the picture taking of the digital camera.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A digital camera comprising:
a camera housing,
an auxiliary lens, and
means for attaching said auxiliary lens to said camera housing.

2. The digital camera as claimed in claim 1, wherein said attaching means includes a bracket attachable to said camera housing, for supporting said auxiliary lens in front of an optical device of said camera housing.

3. The digital camera as claimed in claim 2, wherein said bracket includes a base plate attachable to said camera housing, and a panel extended from said base plate to support said auxiliary lens.

4. The digital camera as claimed in claim 3, wherein said camera housing includes a screw hole formed therein, said base plate includes an orifice formed therein, and a fastener is engageable through said orifice of said base plate, and engageable with said screw hole of said camera housing, to secure said bracket to said camera housing.

5. The digital camera as claimed in claim 4, wherein said fastener includes a retaining ring attached thereto, and engageable with said base plate, for anchoring said fastener to said base plate.

6. The digital camera as claimed in claim 5, wherein said fastener includes a stem extended therefrom, and a threaded portion formed on said stem and engageable with said screw hole of said camera housing, to secure said bracket to said camera housing, said retaining ring is engaged onto said stem of said fastener.

7. The digital camera as claimed in claim 4, wherein said fastener includes a screw hole formed therein, for attaching to a tripod.

8. The digital camera as claimed in claim 3, wherein said bracket includes a pad disposed between said base plate and said camera housing, to protect said camera housing.

9. The digital camera as claimed in claim 3, wherein said panel of said bracket includes an opening formed therein, and an inner thread formed therein for threading to said auxiliary lens.

10. The digital camera as claimed in claim 3 further comprising a barrel attachable to said panel, to support said auxiliary lens.

11. The digital camera as claimed in claim 10, wherein said barrel includes an outer thread for attaching to said panel, and an inner thread for engaging with said auxiliary lens.

12. The digital camera as claimed in claim 11, wherein said barrel includes an additional outer thread formed thereon for attaching to said panel at different position.
